(19) United States
(12) Patent Application Publication
(10) Pub. No.: US 2011/0052969 A1
(43) Pub. Date: Mar. 3, 2011

(54) CELL TAB JOINING FOR BATTERY MODULES

(75) Inventors: Wayne W. Cai, Troy, MI (US); Alexander D. Khakhalev, Troy, MI (US); Roland J. Menassa, Macomb, MI (US); Blair E. Carlson, Ann Arbor, MI (US)

(73) Assignee: GM GLOBAL TECHNOLOGY OPERATIONS, INC., Detroit, MI (US)

(21) Appl. No.: 12/551,594

(22) Filed: Sep. 1, 2009

(51) Int. Cl. H01M 6/42; H01M 2/24

(52) U.S. Cl. 429/158; 429/156

(57) ABSTRACT

A battery module includes a plurality of electrochemical battery cells positioned adjacent one another and each having a positive cell tab and a negative cell tab. The positive cell tab of a first of the electrochemical battery cells is overlappingly joined to the negative cell tab of a second of the plurality of electrochemical battery cells. Each of the positive cell tabs and the negative cell tabs is not joined to a conductive interconnecting member. At least one of the positive cell tabs or the negative cell tabs defines a flexure configured for reducing stress applied to the electrochemical battery cells during overlappingly joining the positive cell tabs and the negative cell tabs.

### TECHNICAL FIELD

The present invention generally relates to a battery module, and more specifically, to a prismatic stack-type battery module for a battery pack.

### BACKGROUND OF THE INVENTION

Batteries are useful for converting chemical energy into electrical energy, and may be described as primary or secondary. Primary batteries are generally non-rechargeable; secondary batteries are readily rechargeable. That is, secondary batteries may be restored to a full charge after use. As such, secondary batteries may be useful for a wide range of applications, such as powering electronic devices, tools, machinery, and vehicles. For example, secondary batteries for vehicle applications may be recharged external to the vehicle via a conventional plug-in electrical outlet, or onboard the vehicle via a regenerative event.

Although primary alkaline, voltaic pile, and lead-acid batteries have been used in numerous household and industrial applications, nickel cadmium (NiCd), nickel-metal hydride (Ni-MH), lithium ion, and lithium ion polymer secondary batteries may be particularly useful for emerging electric and hybrid gas/electric vehicle applications. That is, such secondary batteries often exhibit superior energy densities as compared to conventional primary batteries. Further, secondary batteries may be constructed without a rigid and heavy outer metal battery casing, and may therefore be useful for applications requiring reduced battery size and weight.

A battery, which also may be known as a battery pack, may include one or more battery modules. Similarly, a battery module may include one or more electrochemical battery cells positioned adjacent to each other, e.g., stacked. Further, each electrochemical battery cell may include foil cell tabs that function as conductive terminals. The cell tabs of the electrochemical battery cells may be joined together in a manner suitable for completing an electrical circuit of the battery module. For example, the cell tabs may be joined to a conductive interconnecting member. Therefore, quality and cost advantages may be obtained by optimizing the integrity of the connections, i.e., joints, between the cell tabs.

### SUMMARY OF THE INVENTION

In one embodiment of the present invention, a battery module includes a plurality of electrochemical battery cells positioned adjacent one another and each having a positive cell tab and a negative cell tab. The positive cell tab of a first of the plurality of electrochemical battery cells is overlappingly joined to the negative cell tab of a second of the plurality of electrochemical battery cells. Further, each of the positive cell tabs and the negative cell tabs is not joined to a conductive interconnecting member. Also, at least one of the positive cell tabs or the negative cell tabs defines a flexure configured for reducing stress applied to the electrochemical battery cells during overlappingly joining the positive cell tabs and the negative cell tabs.

In one aspect, the flexure extends along substantially an entire length of at least one of the positive cell tabs and the negative cell tabs. In another aspect, at least one of the positive cell tabs and the negative cell tabs define a plurality of flexures.

In accordance with another aspect, the positive cell tab of the first electrochemical battery cell is bent at a substantially 90 degree angle so as to extend over and contact the negative cell tab of the second electrochemical battery cell. Alternatively, in another aspect, the negative cell tab of the second electrochemical battery cell is bent at a substantially 90 degree angle so as to extend over and contact the positive cell tab of the first electrochemical battery cell.

As part of another aspect of this embodiment, a positive cell tab is positioned adjacent to and in contact with two other positive cell tabs to form a first tab group. In one facet of this aspect, a negative cell tab is positioned adjacent to and in contact with two other negative cell tabs to form a second tab group that is bent at a substantially 90 degree angle so as to extend over and contact the first tab group. In another facet, the second tab group and two positive cell tabs of the first tab group each define a void therethrough that is configured to at least partially overlap with every other void. In an additional facet, one positive cell tab of the first tab group and one negative cell tab of the second tab group each extend beyond the other positive cell tabs of the first tab group and the other negative cell tabs of the second tab group, respectively, and are configured for overlappingly contacting each other.

Alternatively, a negative cell tab is positioned adjacent to and in contact with two other negative cell tabs to form a second tab group that is bent at a substantially 90 degree angle so that the first tab group extends over and contacts the second tab group. In another facet, the first tab group and two negative cell tabs of the second tab group each define a void therethrough that is configured to at least partially overlap with every other void. In yet another facet, one positive cell tab of the first tab group and one negative cell tab of the second tab group each extend beyond the other positive cell tabs of the first tab group and the other negative cell tabs of the second tab group, respectively, and are configured for overlappingly contacting each other.

In another aspect of this embodiment, at least two of the plurality of positive cell tabs and negative cell tabs each define a void therethrough so that at least two voids at least partially overlap.

In yet another aspect, the battery module is a lithium-ion polymer secondary battery module.

In another embodiment, a battery module includes a plurality of electrochemical battery cells each having a positive cell tab and a negative cell tab. The positive cell tabs are stacked adjacent to one another and the negative cell tabs are stacked adjacent to one another. Further, each of the positive cell tabs and the negative cell tabs is not joined to a conductive interconnecting member. The positive cell tabs and the negative cell tabs are joined to one another to thereby form a plurality of joints each having a thickness that is equivalent to one cell tab joined to another cell tab.

In one aspect, at least one of the positive cell tabs and at least one of the negative cell tabs each define a hole that is configured to at least partially overlap with an adjacent positive cell tab or negative cell tab, respectively, at one of the plurality of joints.

In another aspect, at least one of the positive cell tabs and the negative cell tabs define a flexure configured for reducing stress applied to the electrochemical battery cells during joining of the positive cell tabs and the negative cell tabs.

In yet another embodiment, a battery module includes a plurality of electrochemical battery cells and a conductive interconnecting member. The plurality of electrochemical battery cells each has a positive cell tab and a negative cell tab. The positive cell tabs are stacked adjacent to one another and the negative cell tabs are stacked adjacent to one another. Further, the positive cell tabs and the negative cell tabs are joined to the conductive interconnecting member to thereby form a respective first joint and a second joint. Additionally, at least one of the positive cell tabs or the negative cell tabs defines a flexure configured for reducing stress applied to the electrochemical battery cells during joining. The positive cell tabs and the negative cell tabs are each configured for intermeshing at the first joint and the second joint, respectively, so that the first joint and the second joint each has a thickness that is equivalent to one positive cell tab or one negative cell tab joined to the conductive interconnecting member.

In one aspect of this embodiment, each of the positive cell tabs and the negative cell tabs defines one or more holes that are configured to at least partially overlap and intermesh with an adjacent positive cell tab at the first joint and an adjacent negative cell tab at the second joint, respectively.

In another aspect, the positive cell tabs and the negative cell tabs are welded to the conductive interconnecting member.

The battery modules of the present invention are cost-effective to manufacture and optimize the integrity of the connections between the cell tabs of the electrochemical battery cells. As such, the battery modules optimize cell tab joint quality, allow for a variety of cell tab joining processes, experience reduced stresses during cell tab joining, and minimize energy input during cell tab joining.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a portion of a prior art battery module including a conductive interconnecting member;

FIG. 2 is a schematic perspective view of a battery pack and components thereof, including a plurality of electrochemical battery cells and a plurality of battery modules;

FIG. 3 is a schematic plan view of an exemplary electrochemical battery cell having a positive cell tab and a negative cell tab;

FIG. 4A is a schematic perspective partial view of a plurality of positive cell tabs extended over and contacting a plurality of negative cell tabs of one embodiment of the battery module of FIG. 2;

FIG. 4B is a schematic perspective partial view of the plurality of negative cell tabs extended over and contacting the plurality of positive cell tabs of FIG. 4A;

FIG. 5A is a schematic perspective view of a portion of the positive cell tabs and the negative cell tabs of another embodiment of the battery module of FIG. 2, wherein the positive cell tabs and the negative cell tabs are not yet joined to one another;

FIG. 5B is a schematic partial sectional view of a portion of the positive cell tabs and the negative cell tabs of FIG. 5A, wherein the positive cell tabs and the negative cell tabs are joined to one another to thereby form a plurality of joints each having a thickness that is equivalent to one cell tab joined to another cell tab;

FIG. 6 is a schematic top view of a portion of another embodiment of the battery module of FIG. 2;

FIG. 7A is a schematic perspective exploded view of a portion of a plurality of positive cell tabs of the battery module of FIG. 6;

FIG. 7B is a schematic exploded sectional view of a joint and the portion of the plurality of positive cell tabs of FIG. 7A;

FIG. 8A is a schematic perspective partial view of a second tab group and two positive cell tabs of a first tab group of the battery module of FIG. 2, each overlappingly contacting and defining a void therethrough;

FIG. 8B is a schematic perspective partial view of the first tab group of FIG. 8A and two negative cell tabs of the second tab group of FIG. 8A, each overlappingly contacting and defining a void therethrough;

FIG. 9A is a schematic partial sectional view of a portion of the positive cell tabs and the negative cell tabs of the battery module of FIG. 2, wherein one positive cell tab and one negative cell tab each extend beyond the other positive cell tabs and the other negative cell tabs to overlappingly contact each other for joining at point C, and wherein two of the positive cell tabs and two of the negative cell tabs each define a void therethrough so that the voids at least partially overlap for joining at points A and B;

FIG. 9B is a schematic partial sectional view of a portion of the positive cell tabs and the negative cell tabs of the battery module of FIG. 2, wherein at least two of the plurality of positive cell tabs and negative cell tabs each define a void therethrough so that the at least two voids at least partially overlap;

FIG. 9C is a schematic partial sectional view of a portion of the positive cell tabs and the negative cell tabs of the battery module of FIG. 2, wherein one positive cell tab and one negative cell tab each extend beyond the other positive cell tabs and the other negative cell tabs to overlappingly contact each other for joining at point X, and wherein two of the positive cell tabs and two of the negative cell tabs each define a void therethrough so that the voids at least partially overlap for joining at points V, Y, and Z;

FIG. 10A is a schematic partial sectional view of a portion of the positive cell tabs and the negative cell tabs of the battery module of FIG. 2, wherein one positive cell tab and one negative cell tab each extend beyond the other positive cell tabs and the other negative cell tabs to overlappingly contact each other for joining at point C;

FIG. 10B is a schematic partial sectional view of a portion of the positive cell tabs and the negative cell tabs of the battery module of FIG. 2, wherein one positive cell tab and one negative cell tab each extend beyond the other positive cell tabs and the other negative cell tabs to overlappingly contact each other for joining at points P, Q, R, and S; and

FIG. 11 is a schematic perspective view of a positive or negative cell tab of the battery modules of FIG. 2.

### DESCRIPTION OF THE PREFERRED EMBODIMENTS

Referring to the Figures, wherein like reference numerals refer to like components, a battery module is shown generally at 10, 110, 210 in FIG. 2. The battery module 10, 110, 210 may be useful for automotive applications, such as for a plug-in hybrid electric vehicle (PHEV). For example, the battery module 10, 110, 210 may be a lithium-ion polymer secondary battery module. Referring to FIG. 2, a plurality of battery modules 10, 110, 210 may be combined to form a battery pack 12. By way of example, the battery pack 12 may be sufficiently sized to provide a necessary voltage for powering a hybrid electric vehicle (HEV), an electric vehicle (EV), a plug-in hybrid electric vehicle (PHEV), and the like, e.g., approximately 300 to 400 volts or more, depending on the required application. However, it is to be appreciated that the battery module 10, 110, 210 may also be useful for non-automotive applications, such as, but not limited to, household or industrial tools, recreational vehicles, and electronic devices.

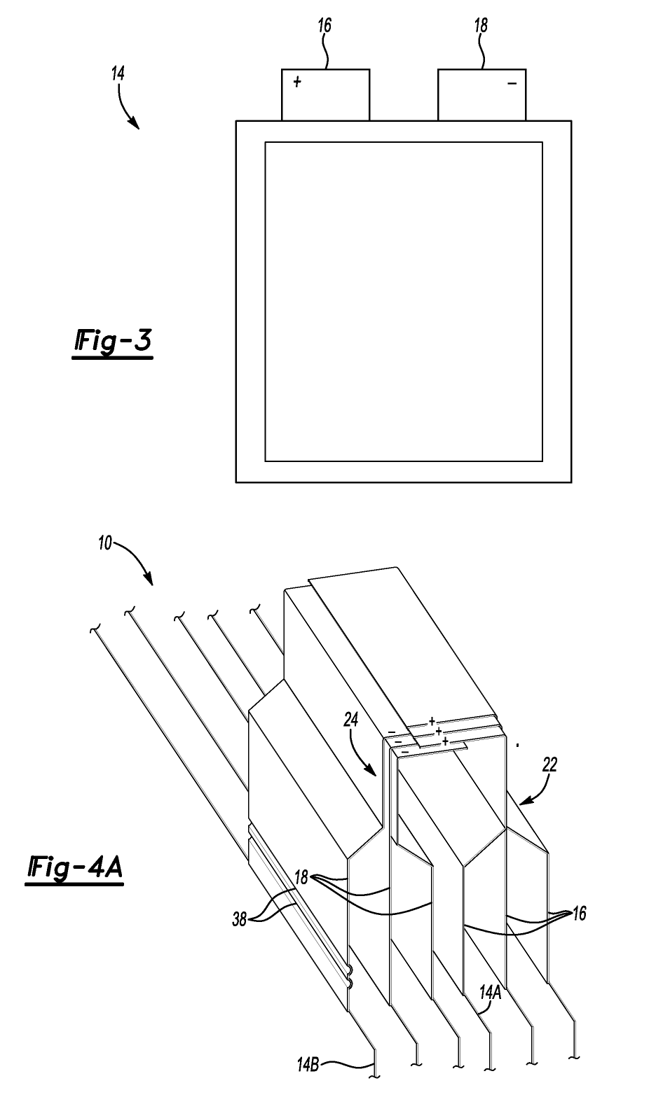

Referring to FIGS. 2 and 3, the battery module 10, 110, 210 includes a plurality of electrochemical battery cells 14 positioned adjacent one another. The electrochemical battery cell 14 may be any suitable electrochemical battery cell known in the art. For example, the electrochemical battery cell 14 may be lithium ion, lithium ion polymer, lithium iron phosphate, lithium vanadium pentoxide, lithium copper chloride, lithium manganese dioxide, lithium sulfur, lithium titanate, nickel metal hydride, nickel cadmium, nickel hydrogen, nickel iron, sodium sulfur, vanadium redox, lead acid, or combinations thereof.

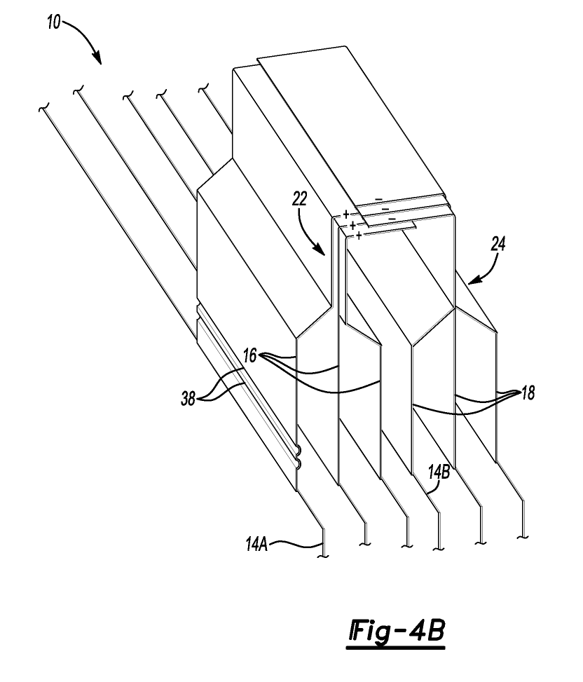

Referring to FIG. 3, each electrochemical battery cell 14 has a positive cell tab 16 and a negative cell tab 18. The electrochemical battery cell 14 may be suitable for stacking. That is, the electrochemical battery cell 14 may be formed from a heat-sealable, flexible foil that is sealed to enclose a cathode, an anode, and a separator (not shown). Therefore, any number of electrochemical battery cells 14 may be stacked or otherwise placed adjacent to each other to form a cell stack, i.e., the battery module 10, 110, 210 (FIG. 2). Further, although not shown in FIG. 2, additional layers, such as, but not limited to, frames and/or cooling layers may also be positioned between individual electrochemical battery cells 14. Consequently, referring generally to embodiments shown in FIGS. 4A-10B, the battery module 10, 110, 210 may include a plurality of positive cell tabs 16 and a plurality of negative cell tabs 18. The actual number of electrochemical battery cells 14 may be expected to vary with the required voltage output of each battery module 10, 110, 210. Likewise, the number of interconnected battery modules 10, 110, 210 may vary to produce the necessary total output voltage for a specific application.

Referring again to FIG. 3, the positive cell tab 16 and the negative cell tab 18 are electrode extensions that are internally welded to various cathodes and anodes (not shown) of the electrochemical battery cell 14, as is understood by one of ordinary skill in the art. The positive cell tab 16 and the negative cell tab 18 may be constructed of a conductive metal. For example, the positive cell tab 16 may be constructed substantially of aluminum, and the negative cell tab 18 may be constructed substantially of copper.

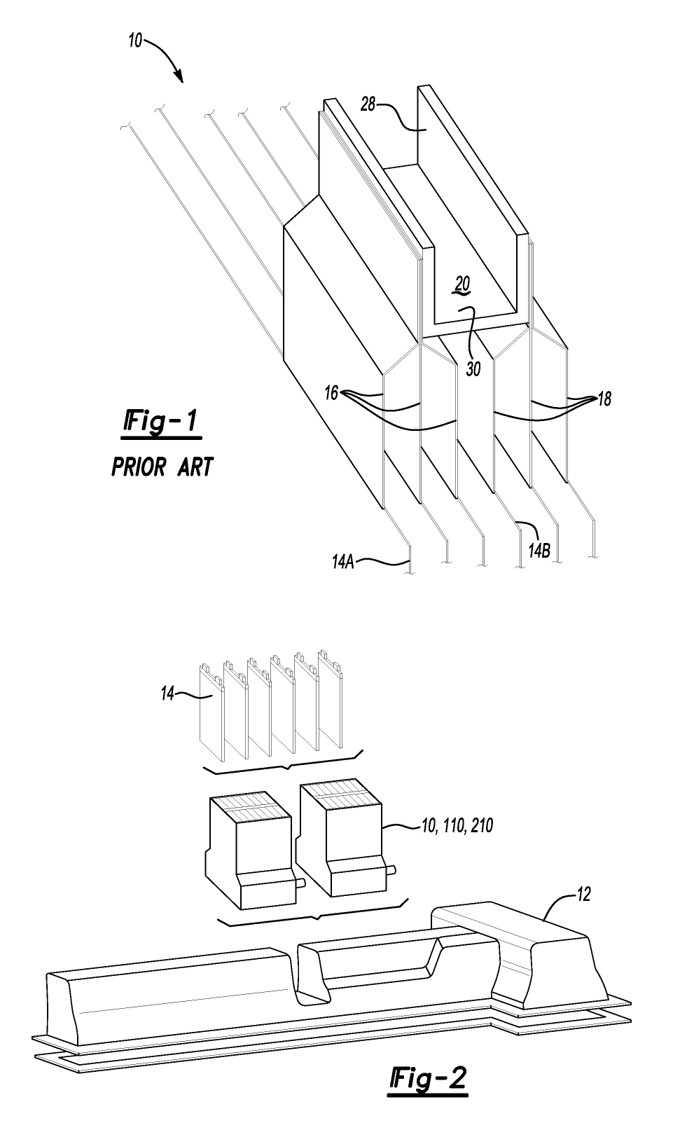

Referring to FIGS. 4A and 4B, the positive cell tab 16 of a first electrochemical battery cell 14A is overlappingly joined to the negative cell tab 18 of a second electrochemical battery cell 14B. For example, referring to FIG. 4A, the positive cell tab 16 of the first electrochemical battery cell 14A may be bent at a substantially 90 degree angle so as to extend over and contact the negative cell tab 18 of the second electrochemical battery cell 14B. Stated differently, the positive cell tab 16 may overlap, i.e., fold over, and contact the negative cell tab 18. Similarly, referring to FIG. 4B, the negative cell tab 18 of the second electrochemical battery cell 14B may be bent at a substantially 90 degree angle so as to extend over and contact the positive cell tab 16 of the first electrochemical battery cell 14A. That is, the negative cell tab 18 may overlap, i.e., fold over, and contact the positive cell tab 16. Therefore, in contrast to the prior art battery module shown in FIG. 1, each of the positive cell tabs 16 and the negative cell tabs 18 is not joined to a conductive interconnecting member 20. Rather, the overlappingly connected positive cell tab 16 and the negative cell tab 18 are connected at one end of the respective first electrochemical battery cell 14A and the second electrochemical battery cell 14B so as to provide electrical conductivity for the battery module 10 without any conductive interconnecting member 20 (FIG. 1). Thus, the battery module 10 is lighter, more compact, and includes fewer components as compared to existing battery modules that may include, for example, the conductive interconnecting member 20 (FIG. 1). Further, because each of the positive cell tabs 16 and the negative cell tabs 18 is not joined to a conductive interconnecting member, manufacturing processes for the battery module 10 are simplified. Consequently, manufacturing costs for the battery module 10 are minimized.

Referring to FIGS. 4A and 4B, in one example, three positive cell tabs 16 may be placed adjacent to each other, i.e., stacked, in the battery module 10 and three negative cell tabs 18 may be placed adjacent to each other, i.e., stacked, in the battery module 10. For example, referring to FIG. 4A, a positive cell tab 16 may be positioned adjacent to and in contact with two other positive cell tabs 16 to form a first tab group 22. That is, one positive cell tab 16 may be positioned between two other positive cell tabs 16 to form the first tab group 22. Therefore, in this example, the first tab group 22 includes three positive cell tabs 16. Likewise, a negative cell tab 18 may be positioned adjacent to and in contact with two other negative cell tabs 18 to form a second tab group 24. That is, one negative cell tab 18 may be positioned between two other negative cell tabs 18 to form the second tab group 24. Therefore, in this example, the second tab group 24 also includes three negative cell tabs 18.

Referring again to FIG. 4A, the first tab group 22 may be bent at a substantially 90 degree angle so as to extend over and contact the second tab group 24. Stated differently, the first tab group 22 may overlap, i.e., fold over, and contact the second tab group 24. Likewise, referring to FIG. 4B, the second tab group 24 may be bent at a substantially 90 degree angle so that the second tab group 24 extends over and contacts the first tab group 22. That is, the second tab group 24 may overlap, i.e., fold over, and contact the first tab group 22.

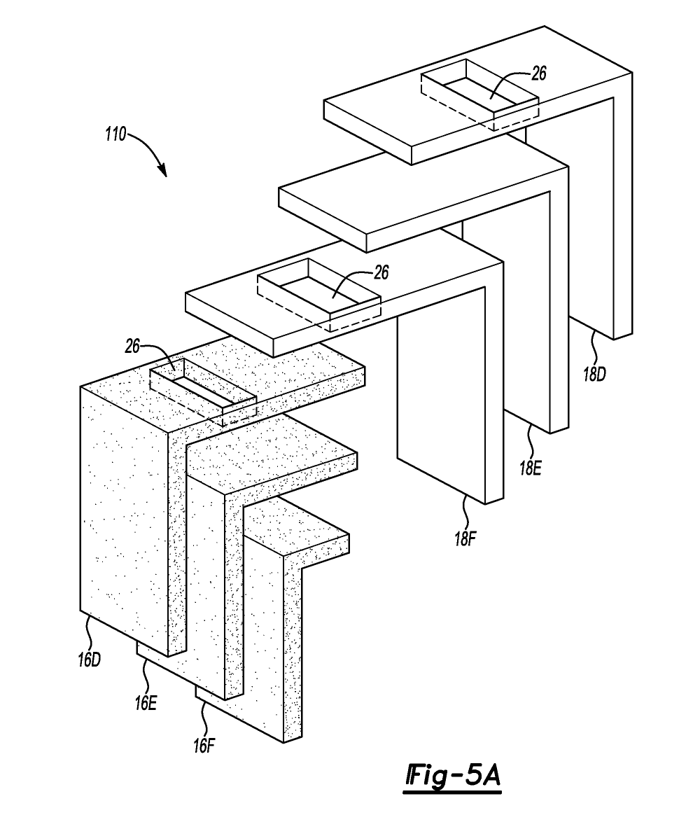

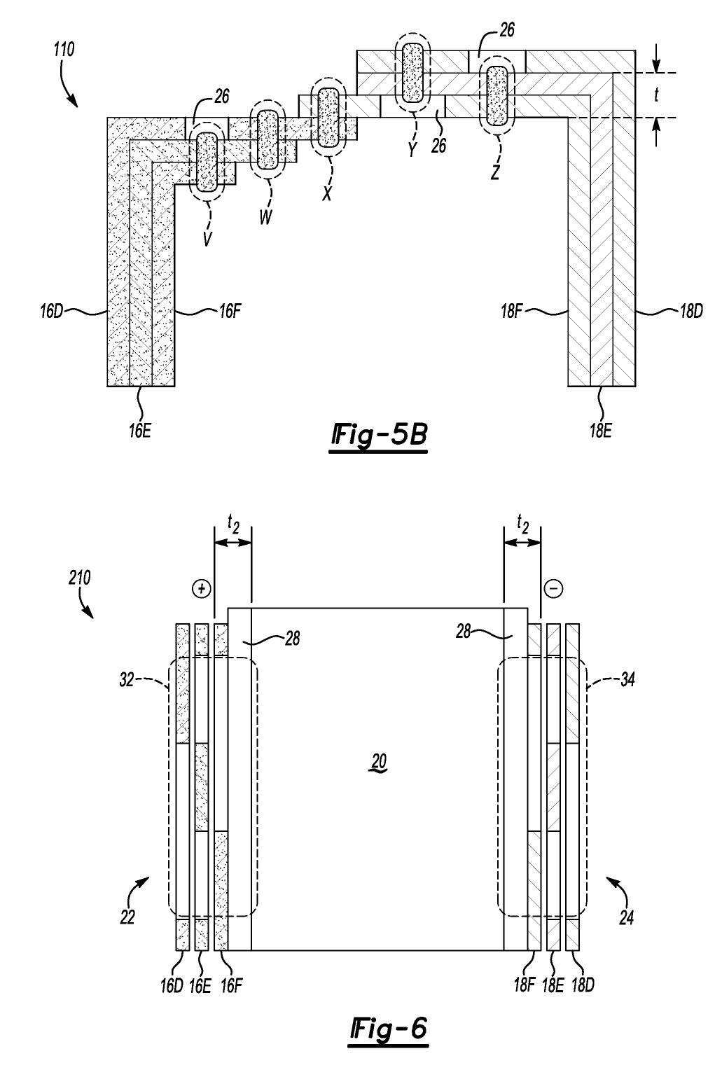

In another embodiment described with respect to FIGS. 5A and 5B, the battery module 110 includes a plurality of electrochemical battery cells 14 (FIG. 3), each having the positive cell tab 16 (FIG. 3) and the negative cell tab 18 (FIG. 3). That is, in one example, the battery module 110 may include two electrochemical battery cells 14. In another example, referring to FIGS. 5A and 5B, the battery module 110 may include at least six electrochemical battery cells 14. That is, as shown in FIG. 5A, the battery module 110 may include at least three positive cell tabs 16D, E, F and at least three negative cell tabs 18D, E, F. Further, although not shown in FIGS. 5A and 5B, the battery module 110 may include more than six electrochemical battery cells 14.

Additionally, as shown in FIG. 5B, one positive cell tab 16D and one negative cell tab 18F may each extend beyond the other positive cell tabs 16E, F and the other negative cell tabs 18D, E, respectively. It is to be appreciated that any one of the positive cell tabs 16D, E, F may extend beyond the other positive cell tabs 16D, E, F. Likewise, any one of the negative cell tabs 18D, E, F may extend beyond the other negative cell tabs 18D, E, F.

Referring to FIG. 5A, in preparation for joining, the positive cell tabs 16D, E, F are positioned with respect to one another and the negative cell tabs 18D, E, F are positioned with respect to one another. Referring to FIG. 5B, after joining, the positive cell tabs 16D, E, F are stacked adjacent to one another and the negative cell tabs 18D, E, F are stacked adjacent to one another.

Referring again to FIGS. 5A and 5B, each of the positive cell tabs 16D, E, F and the negative cell tabs 18D, E, F is not joined to a conductive interconnecting member 20 (FIG. 1). Rather, as shown in FIG. 5B, the positive cell tabs 16D, E, F and the negative cell tabs 18D, E, F are joined to one another to thereby form a plurality of joints, designated by phantom line circles V, W, X, Y, and Z. For example, the positive cell tabs 16D, E, F and the negative cell tabs 18D, E, F may be joined to one another by welding to thereby form five joints. It is also to be appreciated that the positive cell tabs 16D, E, F and the negative cell tabs 18D, E, F may be joined to one another to thereby form more or fewer than five joints, depending upon the configuration of the positive cell tabs 16 and the negative cell tabs 18. For example, the battery module 110 may include only three joints, if at least one of the joints is a 3-layer joint.

Referring again to FIGS. 5A and 5B, at least one of the positive cell tabs 16D, E, F and at least one of the negative cell tabs 18D, E, F may each define a hole 26 that is configured to at least partially overlap with an adjacent positive cell tab 16D, E, F or negative cell tab 18D, E, F, respectively, at one of the plurality of joints designated by phantom line circles V, W, X, Y, Z (FIG. 5B). That is, referring to FIG. 5A, the hole 26 may be a cut-out portion of the positive cell tab 16D, E, F and/or the negative cell tab 18D, E, F. The hole 26 may have any size and/or shape. For example, the hole 26 may be three adjacent slots, one rectangular slot, two adjacent slots, or a combination thereof Additionally, one or more positive cell tabs 16D, E, F and/or one or more negative cell tab 18D, E, F may each define a plurality of holes 26.

Prior to joining (FIG. 5A), the plurality of positive cell tabs 16D, E, F of the electrochemical battery cells 14 (FIG. 3) may be stacked adjacent to each other to at least partially overlap the holes 26 at the desired locations for the plurality of joints designated by phantom line circles V, W, X,Y, Z (FIG. 5B). Likewise, the plurality of negative cell tabs 18D, E, F may be stacked adjacent to each other to at least partially overlap the holes 26.

Referring to FIG. 5B, upon joining, the plurality of joints designated by phantom line circles V, W, X, Y, Z each has a thickness, t, that is equivalent to one cell tab 16D, E, F, 18D, E, F joined to another cell tab 16D, E, F, 18D, E, F. That is, the positive cell tabs 16D, E, F at least partially overlap with the negative cell tabs 18D, E, F via the holes 26 to form the plurality of joints designated by phantom line circles V, W, X, Y, Z. Stated differently, referring to FIG. 5B, the thickness, t, of each of the entire joints designated by phantom line circles V, W, X, Y, Z may be equivalent in thickness to a joint between, for example, only one positive cell tab 16F and one negative cell tab 18F, one positive cell tab 16D and another positive cell tab 16E, or one negative cell tab 18D and another negative cell tab 18E. That is, the thickness, t, is equivalent to the thickness of two joined cell tabs 16D, E, F, 18D, E, F and forms a 2-layer joint.

Further, it is to be appreciated that the at least one hole 26, the positive cell tabs 16D, E, F, and/or the negative cell tabs 18D, E, F may be arranged in any other suitable configuration to provide some or all of the plurality of joints designated by phantom line circles V, W, X, Y, Z each having the thickness, t, equivalent to the thickness of two joined cell tabs 16D, E, F, 18D, E, F. That is, for example, although not shown in FIGS. 5A and 5B, the positive cell tabs 16D, E, F may be stacked alternatingly with the negative cell tabs 18D, E, F.

The resulting 2-layer joints designated by phantom line circles V, W, X, Y, Z have a reduced number of layers as compared to, for example, a 4-layer joint, and therefore optimize the ease of joining the cell tabs 16D, E, F, 18D, E, F of the electrochemical battery cells 14. Consequently, the resulting 2-layer joints may also have a reduced thickness, t. A minimization of the number of layers and/or thickness of the joints is desirable, since a 2-layer joint is easier to join than, for example, a 4- or more-layer joint. As such, the battery module 110 has excellent weldability and weld quality. More specifically, the battery module 110 optimizes cell tab joint quality, allows for a variety of cell tab joining processes, experiences reduced stresses during cell tab joining, and minimizes energy input during cell tab joining as compared to a 4- or more-layer joint.

Moreover, it is to be appreciated that the exemplary configurations shown in FIGS. 5A and 5B may be combined with the exemplary configurations shown in FIGS. 4A and 4B. That is, the first tab group 22 and/or the second tab group 24 may define one or more holes 26. Further, the first tab group 22 and/or the second tab group 24 may be bent at a substantially 90 degree angle for overlappingly joining the positive cell tabs 16D, E, F and the negative cell tabs 18D, E, F.

In another embodiment, described generally with respect to FIG. 6, a battery module 210 includes a plurality of electrochemical battery cells 14 (FIG. 3) each having the positive cell tab 16 (FIG. 3) and the negative cell tab 18 (FIG. 3). In one example, the battery module 210 may include two electrochemical battery cells 14. In another example, referring to FIG. 6, which is not drawn to scale, the battery module 210 may include at least six electrochemical battery cells 14. That is, referring to FIG. 6, the battery module 210 may include a plurality of positive cell tabs 16D, E, F and/or a plurality of negative cell tabs 18D, E, F. Further, in this embodiment, the positive cell tabs 16D, E, F are stacked adjacent to one another and the negative cell tabs 18D, E, F are stacked adjacent to one another.

The battery module 210 also includes a conductive interconnecting member, shown generally at 20 in FIG. 6. Referring to FIGS. 1 and 6, the conductive interconnecting member 20, may be shaped, sized, or otherwise configured to form an elongated rail or bus bar. For example, referring to FIG. 1, an exemplary conductive interconnecting member 20 may include a pair of side walls 28 that are each operatively connected to or formed integrally with a base 30 to define a generally U-shaped profile. Further, the conductive interconnecting member 20 may be constructed of any suitable conductive material, e.g., pure or elemental copper, or at least approximately 90% copper if an alloy of elemental copper is used. Additionally, the battery module 210 may also include more than one conductive interconnecting member 20.

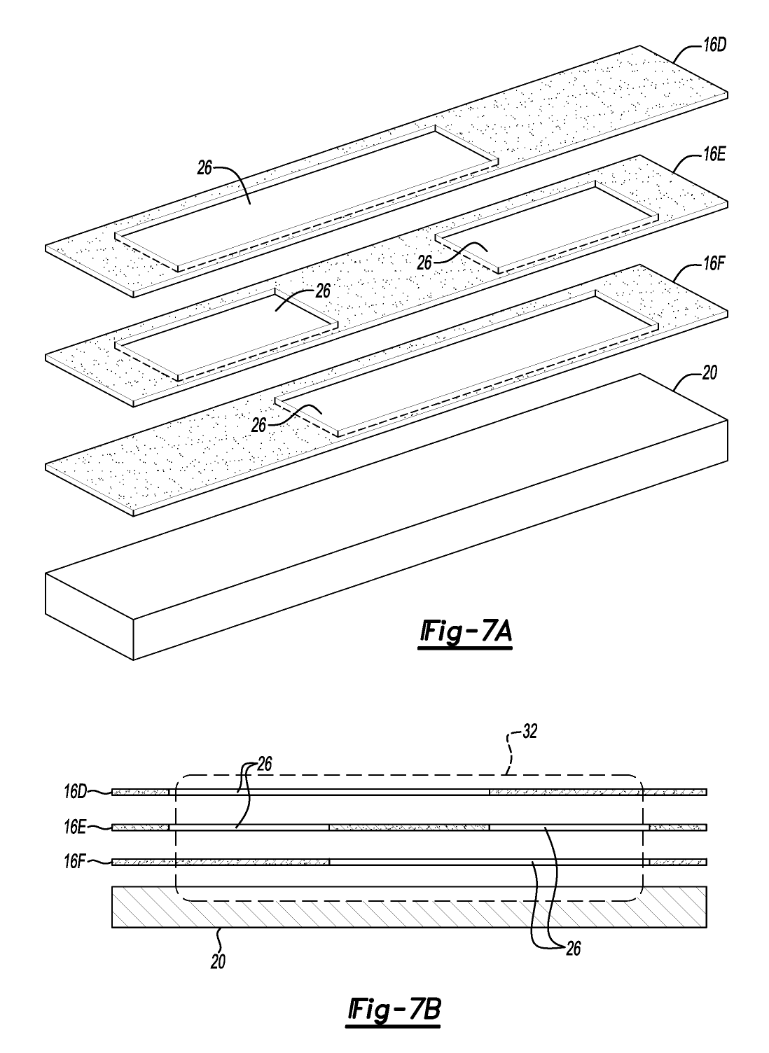

Referring to FIG. 6, the positive cell tabs 16D, E, F and the negative cell tabs 18D, E, F are joined to the conductive interconnecting member 20 to thereby form a respective first joint 32 and a second joint 34. For illustration, the first joint 32 and the second joint 34 are shown in exploded, i.e., non-joined, view in FIGS. 6, 7A, and 7B. The positive cell tabs 16D, E, F and the negative cell tabs 18D, E, F may be joined by any suitable joining technique or method known in the art. For example, the positive cell tabs 16D, E, F and the negative cell tabs 18D, E, F may be welded to the conductive interconnecting member 20. As known in the art, welding may utilize oscillations or vibrations in a particular range of frequency to bond adjacent plastic or metallic work pieces, e.g., the positive cell tab 16 and the conductive interconnecting member 20. More specifically, the positive cell tabs 16D, E, F and the negative cell tabs 18D, E, F may be welded to the conductive interconnecting member 20, e.g., using a horn, i.e., sonotrode, and anvil style ultrasonic welding apparatus (not shown). The first joint 32 and the second joint 34 should be of sufficient quality to ensure electrical conduction between the positive cell tabs 16D, E, F, the conductive interconnecting member 20, and the negative cell tabs 18D, E, F, thereby ensuring electrical conductivity of the battery module 210.

As shown in FIG. 6, the first joint 32 may be formed between the positive cell tabs 16 and one of the side walls 28 of the conductive interconnecting member 20. Likewise, the second joint 34 may be formed between the negative cell tabs 18 and one of the side walls 28 of the conductive interconnecting member 20. Further, the first joint 32 and the second joint 34 may be formed at opposite ends of the conductive interconnecting member 20.

Referring to FIGS. 6, 7A, and 7B, the positive cell tabs 16D, E, F and the negative cell tabs 18D, E, F are each configured for intermeshing at the first joint 32 and the second joint 34, respectively, so that the first joint 32 and the second joint 34 each has a thickness, t₂, (FIG. 6) that is equivalent to one positive cell tab 16 or one negative cell tab 18 joined to the conductive interconnecting member 20. Stated differently, referring to FIG. 6 and described with respect to the positive cell tabs 16D, E, F and the first joint 32, after joining, the thickness, t₂, of the entire first joint 32 may be equivalent in thickness to a joint between only one positive cell tab 16 and the conductive interconnecting member 20. Similarly, as shown in FIG. 6, the thickness, t₂, of the second joint 34 after joining may also be equivalent in thickness to a joint between only one negative cell tab 18 and the conductive interconnecting member 20. The resulting 2-layer joint 32, 34 has a reduced number of layers as compared to, for example, a 4-layer joint, and therefore provides the associated advantages of excellent weldability as set forth above.

Referring to FIG. 7A, in this embodiment, each of the positive cell tabs 16D, E, F and the negative cell tabs 18D, E, F may define one or more holes 26 that are configured to at least partially overlap and intermesh with an adjacent positive cell tab 16D, E, F at the first joint 32 and an adjacent negative cell tab 18D, E, F at the second joint 34, respectively. For example, referring to FIGS. 7A and 7B and described with respect to the positive cell tabs 16D, E, F, the plurality of positive cell tabs 16D, E, F of the plurality of electrochemical battery cells 14 (FIG. 3) may be stacked adjacent to each other. Each of the positive cell tabs 16D, E, F may define one or more holes 26 that are configured to at least partially overlap and intermesh with an adjacent positive cell tab 16D, E, F at the first joint 32.

That is, in one example, four layers, i.e., a first, second, and third positive cell tab 16F, E, D and the conductive interconnecting member 20 may be stacked adjacent to each other in preparation for joining (FIG. 7A). Referring to FIG. 7A, the second layer (the first positive cell tab 16F) may define one hole 26, i.e., cutout, configured to intermesh with the third layer (the second positive cell tab 16E) during joining, e.g., welding. Likewise, referring to FIG. 7A, the third layer (the second positive cell tab 16E) may define two holes 26 configured to intermesh with both the second layer (the first positive cell tab 16F) and the fourth layer (the third positive cell tab 16D), respectively. Similarly, referring to FIG. 7A, the fourth layer (the third positive cell tab 16D) may define one hole 26 configured to intermesh with the third layer (the second positive cell tab 16E). Therefore, when the four layers are joined, the first joint 32 may be two layers thick throughout the first joint 32. Stated differently, the thickness, t₂, (FIG. 6) of the first joint 32 is at most equal to the thickness of one positive cell tab 16 joined to the conductive interconnecting member 20 at any position of the first joint 32.

The resulting 2-layer joint, e.g., the first joint 32, has a reduced number of layers as compared to, for example, a 4-layer joint, and therefore optimizes the ease of joining the cell tabs 16D, E, F, 18D, E, F of the electrochemical battery cells 14. Consequently, the resulting 2-layer joint 32, 34 may also have a reduced thickness, t. As set forth above, a minimization of the number of layers and/or thickness of the joints 32, 34 is desirable. As such, the battery module 210 has excellent weldability and weld quality. That is, the battery module 210 optimizes cell tab joint quality, allows for a variety of cell tab joining processes, experiences reduced stresses during cell tab joining, and minimizes energy input during cell tab joining as compared to a 4- or more-layer joint.

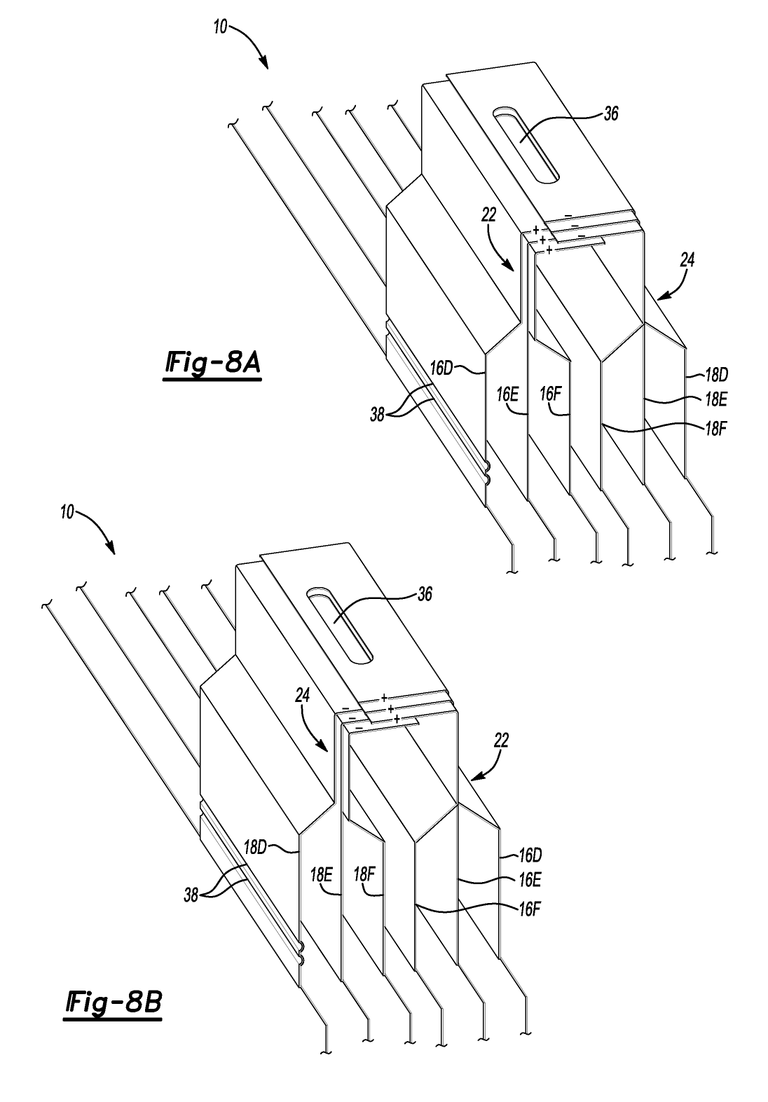

Referring now to FIG. 8A, the second tab group 24 and two positive cell tabs 16D, E of the first tab group 22 may each define a void 36 therethrough that is configured to at least partially overlap with every other void 36. That is, each negative cell tab 18D, E, F of the second tab group 24, and the topmost two positive cell tabs 16D, E of the first tab group 22 may each define the void 36 so that each void 36 at least partially overlaps every other void 36 as the first tab group 22 and the second tab group 24 are overlappingly joined, i.e., as the second tab group 24 overlaps and contacts the first tab group 22. In this example, the second tab group 24 and two positive cell tabs 16D, E of the first tab group 22 may define a 1-layer joint that may be joined, for example, by soldering.

Similarly, referring to FIG. 8B, the first tab group 22 and two negative cell tabs 18D, E of the second tab group 24 may each define the void 36 therethrough that is configured to at least partially overlap with every other void 36. That is, each positive cell tab 16D, E, F of the first tab group 22, and the topmost two negative cell tabs 18D, E of the second tab group 24 may each define the void 36 so that each void 36 at least partially overlaps every other void 36 as the second tab group 24 and the first tab group 22 are overlappingly joined, i.e., as the first tab group 22 overlaps and contacts the second tab group 24. In this example, the first tab group 22 and two negative cell tabs 18D, E of the second tab group 24 may define a 1-layer joint that may also be joined, for example, by soldering.

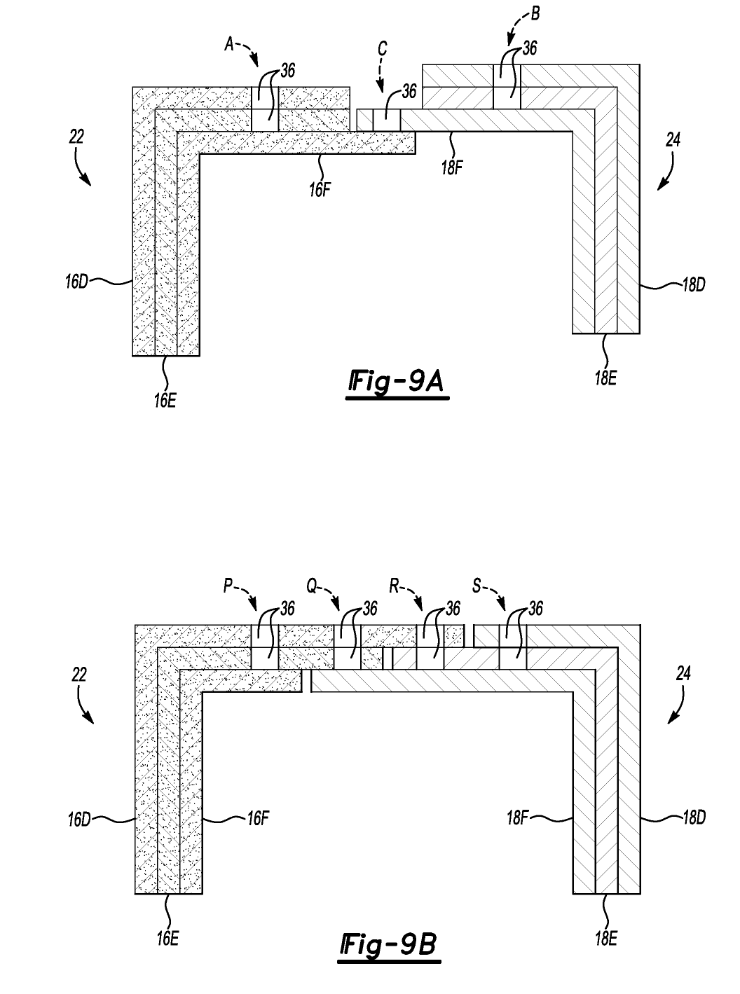

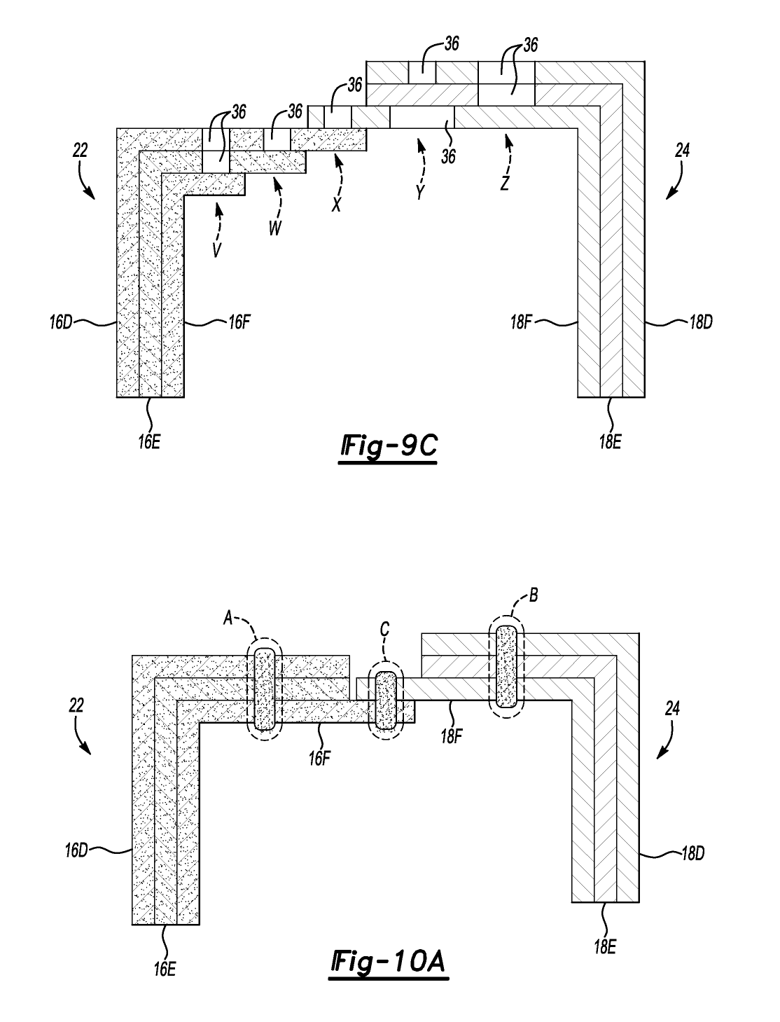

In another example, referring to FIGS. 9A, 9B, and 9C, at least two of the plurality of positive cell tabs 16D, E, F and negative cell tabs 18D, E, F may each define the void 36 therethrough so that the at least two voids 36 at least partially overlap. For example, referring to FIGS. 9A-9C, two of the positive cell tabs 16D, E and two of the negative cell tabs 18D, E may each define the void 36 therethrough. The two voids 36 of the positive cell tabs 16D, E may each at least partially overlap and the two voids 36 of the negative cell tabs 18D, E may each at least partially overlap. Similarly, referring to FIG. 9B, two of the positive cell tabs 16D, E may each define two voids 36, and one of the negative cell tabs 18E may define two voids 36. In this example, each set of voids 36 of the positive cell tabs 16D, E may at least partially overlap and the voids 36 of the negative cell tabs 18D, E may at least partially overlap. And, one or more voids 36 of the positive cell tab 16D may at least partially overlap with one or more of the negative cell tabs 18E. Likewise, referring to FIG. 9C, two of the negative cell tabs 18D, F may each define two voids 36 therethrough so that the at least one set of voids 36 of the negative cell tabs 18D, E (or 18 D, F) may at least partially overlap.

The void 36 may have any suitable shape, such as, but not limited to, elongated, circular, rectangular, and/or oval. In addition, the first tab group 22 and/or the second tab group 24 may each define a plurality of voids 36 to form, for example, a screen or mesh. Further, each void 36 may have the same or different size and/or shape, as long as each void 36 at least partially overlaps with every other void 36 when the first tab group 22 and the second tab group 24 are overlappingly joined.

The void 36 may be suitable for receiving, for example, molten or paste solder so that the first tab group 22 and the second tab group 24 may be soldered. It is also to be appreciated that the soldering may be reversible so that the first tab group 22 and/or the second tab group 24 may be disassembled. The resulting soldered joint, shown generally at points A and B in FIG. 9A, points P, Q, R, and S in FIG. 9B, and points V, W, X, Y, and Z in FIG. 9C, for example, has a thickness equivalent to a thickness of only one positive or negative cell tab 16, 18. That is, the resulting joint is a 1-layer joint that may be joined by soldering. Therefore, the one or more voids 36 allow for a reduction in the number of layers and/or the thickness of each joint of the battery module 10.

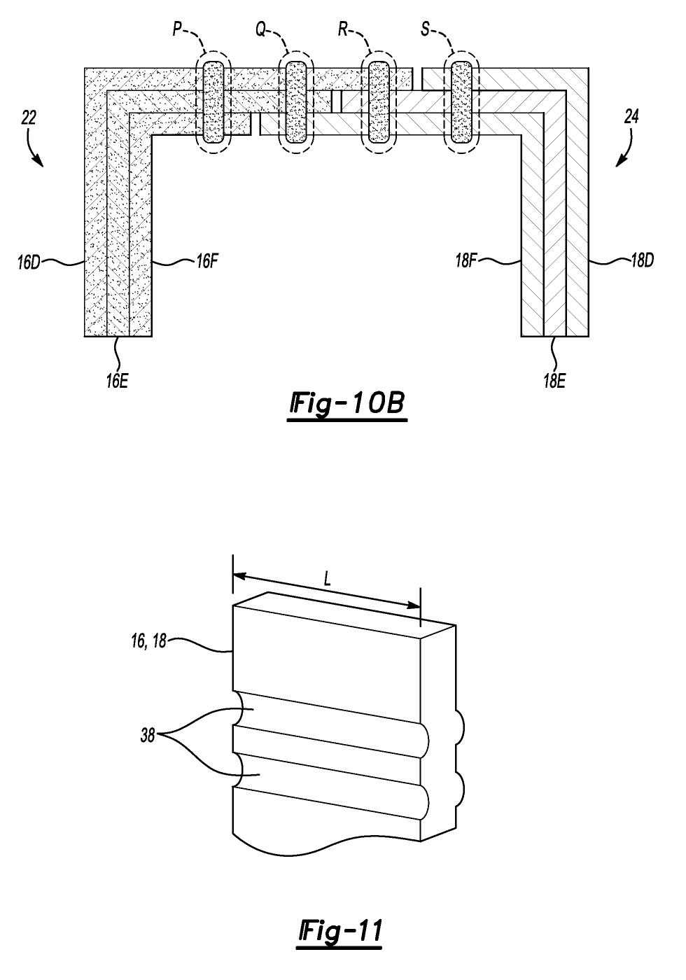

Additionally, referring to FIGS. 9A and 10A, one positive cell tab 16F of the first tab group 22 and one negative cell tab 18F of the second tab group 24 may each extend beyond the other positive cell tabs 16D, E of the first tab group 22 and the other negative cell tabs 18D, E of the second tab group 24, respectively, and may be configured for overlappingly contacting each other. That is, for example, one bottommost positive cell tab 16F of the first tab group 22 and one bottommost negative cell tab 18F of the second tab group 24 may be longer than the other adjacent positive cell tabs 16D, E and negative cell tabs 18D, E, respectively. Therefore, referring to FIGS. 9A and 10A, one bottommost positive cell tab 16F and one bottommost negative cell tab 18F may be configured for overlapping and contacting each other. It is to be appreciated that, in this example, the one negative cell tab 18F may overlap and contact the positive cell tab 16F (as shown in FIG. 9A), or that the one positive cell tab 16F may overlap and contact the negative cell tab 18F.

It is also to be appreciated that multiple variations of cell tab arrangements are possible and contemplated. For example, referring to FIGS. 9B and 10B, more than one positive cell tab, e.g., 16D, E, of the first tab group 22 and/or more than one negative cell tab, e.g., 18F, E of the second tab group 24 may each extend beyond the other positive cell tab 16F of the first tab group 22 and the other negative cell tab 18D of the second tab group 24, respectively, and may be configured for overlappingly contacting each other. And, any of the positive cell tabs 16D, E, F and the negative cell tabs 18D, E, F may extend beyond the other positive cell tabs 16 and negative cell tabs 18. For example, a topmost positive cell tab 16D (FIG. 5B, 9B, 9C, and 10B) and a bottommost negative cell tab 18F may each extend beyond the other positive cell tabs 16E, F and negative cell tabs 18D, E, respectively, and may be configured for overlappingly contacting each other.

In the aforementioned examples, the first tab group 22 and the second tab group 24 may be overlapping joined by any suitable method. For example, the first tab group 22 and the second tab group 24 may be vibration welded, ultrasonically welded, resistance spot welded, soldered, glued, and/or riveted. More specifically, in one example, the first tab group 22 and the second tab group 24 may be ultrasonically welded via a controlled application of pressure and high-frequency mechanical vibration to form a solid bond or joint.

Referring to FIG. 10A, in one example, the first tab group 22 and the second tab group 24 may be welded at three points, designated by phantom line circles A, B, and C. In another example, the first tab group 22 and the second tab group 24 may be welded at four points, designated by phantom line circles P, Q, R, and S in FIG. 10B. In yet another example, the first tab group 22 and the second tab group 24 may be welded at five points, designated by phantom line circles V, W, X, Y, and Z in FIG. 5B. Although not shown, the first tab group 22 and the second tab group 24 may also be joined at fewer than three joints.

More specifically, referring to phantom line circles A (FIG. 10A) and P (FIG. 10B), the positive cell tabs 16D, E, F of the first tab group 22 may be welded to each other to form a 3-layer joint. Similarly, referring to phantom line circles B (FIG. 10A) and S (FIG. 10B), the negative cell tabs 18D, E, F of the second tab group 24 may be welded to each other to form a 3-layer joint. Additionally, referring to phantom line circle Q (FIG. 10B), the one bottommost negative cell tab 18F may be welded to two positive cell tabs 16D, E to form a 3-layer joint. Likewise, referring to phantom line circle R (FIG. 10B), the one topmost positive cell tab 16D may be welded to two negative cell tabs 18E, F.

And, referring to phantom line circles C (FIG. 10A) and X (FIG. 5B), the one bottommost negative cell tab 18F and the one bottommost positive cell tab 16F may be welded to each other to form a 2-layer joint. Similarly, referring to phantom line circle V (FIG. 5B), two positive cell tabs 16E, F may be welded to each other. Referring to phantom line circle Z (FIG. 5B), two negative cell tabs 18 may also be welded to each other.

Referring to FIGS. 5B, 10A, and 10B as examples, the resulting 3-layer joints of phantom line circles A, B, P, Q, R, and S, and the 2-layer joints of phantom line circles C, V, W, X, Y, and Z are easily joined. That is, 2-layer and 3-layer joints are easier to join than, for example, a 4-layer joint. As such, the battery module 10, 110 exhibits excellent weldability as compared to existing battery modules.

Referring now to FIG. 11, at least one of the positive cell tabs 16 or the negative cell tabs 18 of the battery module 10, 210 defines a flexure 38. In general, the flexure 38 may reduce stress applied to the electrochemical battery cell 14 during joining and/or during vehicle operation. Any or all of each of the positive cell tabs 16 and the negative cell tabs 18 may define the flexure 38. For applications including the battery module 10, the flexure 38 is configured for reducing stress applied to the electrochemical battery cell 14 (FIG. 3) during overlappingly joining the positive cell tabs 16 and the negative cell tabs 18. Likewise, for applications including the battery module 210, the flexure 38 is configured for reducing stress applied to the electrochemical cells 14 during joining.

For applications including the battery module 110, at least one of the positive cell tabs 16 and the negative cell tabs 18 may each define the flexure 38 configured for reducing stress applied to the electrochemical battery cells 14 (FIG. 3) during joining of the positive cell tabs 16 and the negative cell tabs 18.

In particular, the electrochemical battery cell 14, and more specifically, joints at points A, B, and C (FIG. 10A); P, Q, R, and S (FIG. 10B); V, W, X, Y, and Z (FIG. 5B); the first joint 32 (FIG. 6); the second joint 34 (FIG. 6); and/or internal joints of the various cathodes and anodes (not shown) of the electrochemical battery cell 14, may be subjected to shear stress during joining, particularly during welding, and/or during vehicle operation. For example, during manufacturing of the battery module 10, 110, 210 and/or during vehicle operation, vibrations may be transmitted to internal joints (not shown) of the electrochemical battery cell 14 and may cause undesirable deformation and stress unless dissipated. That is, during manufacturing of the battery module 110 for example, the second joint 34 may be formed after the first joint 32. Therefore, as a horn of a welding apparatus (not shown) vibrates at a high frequency to form the second joint 34, vibrations may be transmitted to the first joint 32 and any internal joints (not shown). Depending on the amplitude of the vibrations, the first joint 32 may experience shear stress and undesirable deformation and stress, thereby affecting the joint quality of the battery module 110. Similarly, during vehicle operation, vibrations may be transmitted to internal joints (not shown) of the electrochemical battery cell 14 and may cause undesirable deformation unless dissipated. That is, without intending to be limited by theory, the flexure 38 may allow the positive cell tab 16 and/or the negative cell tab 18 to flex, bend, accordion, and/or compress to thereby minimize deformation and stress of the battery module 10, 110, 210.

Referring to FIG. 11, the flexure 38 may extend along substantially an entire length, L, of at least one of the positive cell tabs 16 and the negative cell tabs 18. As used herein, the terminology “substantially” is used to represent the inherent degree of uncertainty that may be attributed to any quantitative comparison, value, measurement, or other representation. The terminology also represents the degree by which a quantitative representation may vary from a stated reference without resulting in a change in the basic function of the subject matter at issue. Therefore, it is contemplated that the flexure 38 may extend along slightly less than the entire length, L, of at least one of the positive cell tabs 16 and the negative cell tabs 18.

Further, referring to FIG. 11, the flexure 38 may have any suitable shape, such as, but not limited to, a box-like-shape or S-shape. In one example, the flexure 38 may be substantially C-shaped. In another example, the flexure 38 may be a bend in the positive cell tab 16 or negative cell tab 18. Further, referring to FIG. 11, at least one of the positive cell tabs 16 and the negative cell tabs 18 may define a plurality of flexures 38. For example, at least one of the positive cell tabs 16 and the negative cell tabs 18 may define two or more flexures 38. Also, the positive cell tabs 16 may define the same number of, fewer, or more flexures 38 than the negative cell tabs 18.

While the best modes for carrying out the invention have been described in detail, those familiar with the art to which this invention relates will recognize various alternative designs and embodiments for practicing the invention within the scope of the appended claims.

1. A battery module comprising:
a plurality of electrochemical battery cells positioned adjacent one another and each having a positive cell tab and a negative cell tab;
wherein said positive cell tab of a first of said plurality of electrochemical battery cells is overlappingly joined to said negative cell tab of a second of said plurality of electrochemical battery cells;
wherein each of said positive cell tabs and said negative cell tabs is not joined to a conductive interconnecting member;
wherein at least one of said positive cell tabs or said negative cell tabs defines a flexure configured for reducing stress applied to said electrochemical battery cells during overlappingly joining said positive cell tabs and said negative cell tabs.

2. The battery module of claim 1, wherein said flexure extends along substantially an entire length of at least one of said positive cell tabs and said negative cell tabs.

3. The battery module of claim 1, wherein at least one of said positive cell tabs and said negative cell tabs define a plurality of flexures.

4. The battery module of claim 1, wherein said positive cell tab of said first electrochemical battery cell is bent at a substantially 90 degree angle so as to extend over and contact said negative cell tab of said second electrochemical battery cell.

5. The battery module of claim 1, wherein said negative cell tab of said second electrochemical battery cell is bent at a substantially 90 degree angle so as to extend over and contact said positive cell tab of said first electrochemical battery cell.

6. The battery module of claim 1, wherein a positive cell tab is positioned adjacent to and in contact with two other positive cell tabs to form a first tab group.

7. The battery module of claim 6, wherein a negative cell tab is positioned adjacent to and in contact with two other negative cell tabs to form a second tab group that is bent at a substantially 90 degree angle so as to extend over and contact said first tab group.

8. The battery module of claim 6, wherein a negative cell tab is positioned adjacent to and in contact with two other negative cell tabs to form a second tab group that is bent at a substantially 90 degree angle so that said first tab group extends over and contacts said second tab group.

9. The battery module of claim 1, wherein at least two of said plurality of positive cell tabs and negative cell tabs each define a void therethrough so that said at least two voids at least partially overlap.

10. The battery module of claim 7, wherein said second tab group and two positive cell tabs of said first tab group each define a void therethrough that is configured to at least partially overlap with every other void.

11. The battery module of claim 8, wherein said first tab group and two negative cell tabs of said second tab group each define a void therethrough that is configured to at least partially overlap with every other void.

12. The battery module of claim 7, wherein one positive cell tab of said first tab group and one negative cell tab of said second tab group each extend beyond said other positive cell tabs of said first tab group and said other negative cell tabs of said second tab group, respectively, and are configured for overlappingly contacting each other.

13. The battery module of claim 8, wherein one positive cell tab of said first tab group and one negative cell tab of said second tab group each extend beyond said other positive cell tabs of said first tab group and said other negative cell tabs of said second tab group, respectively, and are configured for overlappingly contacting each other.

14. The battery module of claim 1, wherein said battery module is a lithium-ion polymer secondary battery module.

15. A battery module comprising:
a plurality of electrochemical battery cells each having a positive cell tab and a negative cell tab;
wherein said positive cell tabs are stacked adjacent to one another and said negative cell tabs are stacked adjacent to one another;
wherein each of said positive cell tabs and said negative cell tabs is not joined to a conductive interconnecting member;
wherein said positive cell tabs and said negative cell tabs are joined to one another to thereby form a plurality of joints each having a thickness that is equivalent to one cell tab joined to another cell tab.

16. The battery module of claim 15, wherein at least one of said positive cell tabs and at least one of said negative cell tabs each define a hole that is configured to at least partially overlap with an adjacent positive cell tab or negative cell tab, respectively, at one of said plurality of joints.

17. The battery module of claim 15, wherein at least one of said positive cell tabs and said negative cell tabs define a flexure configured for reducing stress applied to said electrochemical battery cells during joining of said positive cell tabs and said negative cell tabs.

18. A battery module comprising:
a plurality of electrochemical battery cells each having a positive cell tab and a negative cell tab; and
a conductive interconnecting member;
wherein said positive cell tabs are stacked adjacent to one another and said negative cell tabs are stacked adjacent to one another;
wherein said positive cell tabs and said negative cell tabs are joined to said conductive interconnecting member to thereby form a respective first joint and a second joint;
wherein at least one of said positive cell tabs or said negative cell tabs defines a flexure configured for reducing stress applied to said electrochemical battery cells during joining;
wherein said positive cell tabs and said negative cell tabs are each configured for intermeshing at said first joint and said second joint, respectively, so that said first joint and said second joint each has a thickness that is equivalent to one positive cell tab or one negative cell tab joined to said conductive interconnecting member.

19. The battery module of claim 18, wherein each of said positive cell tabs and said negative cell tabs defines one or more holes that are configured to at least partially overlap and intermesh with an adjacent positive cell tab at said first joint and an adjacent negative cell tab at said second joint, respectively.

20. The battery module of claim 18, wherein said positive cell tabs and said negative cell tabs are welded to said conductive interconnecting member.
